(19) United States
(12) Patent Application Publication
(10) Pub. No.: US 2012/0158440 A1
(43) Pub. Date: Jun. 21, 2012

(54) MORTGAGE FORECLOSURE INSURANCE PRODUCT AND METHOD OF HEDGING INSURER RISK IN A MORTGAGE FORECLOSURE INSURANCE PRODUCT

(76) Inventors: Wallace Benward, Rancho Santa Fe, CA (US); Branden D. Rife, Carlsbad, CA (US)

(21) Appl. No.: 13/408,855

(22) Filed: Feb. 29, 2012

Related U.S. Application Data
(63) Continuation of application No. 12/292,328, filed on Nov. 17, 2008.
(60) Provisional application No. 61/003,655, filed on Nov. 19, 2007.

(51) Int. Cl. G06Q 40/08

(52) U.S. Cl. 705/4

(57) ABSTRACT

A method, non-transitory machine-readable medium, and financial product provide borrower foreclosure insurance for insured interests in real property, each classified in a rate category. A processor is controlled to calculate a premium for at least some of the real property interests with a rule utilizing the data indicative of the rate category and storing the calculation. The processor receives data indicative of a cost of a hedge vehicle respectively associated with each real property interest. A hedge vehicle is selected based on an index for real property in a preselected geographical area. A monetary level to hedge is selected, and a hedge vehicle or vehicles are selected. A number of hedge contracts of at least one type to achieve hedging of the monetary level is calculated on the processor.

### CROSS-REFERENCE TO RELATED APPLICATIONS

This application is a continuation application Ser. No. 12/292,328, entitled “Mortgage Foreclosure Insurance Product and Method for Hedging and Calculating Premiums,” filed on Nov. 17, 2008 by Wallace Benward and Branden Dwayne Rife, which is incorporated herein by reference in its entirety.

### BACKGROUND OF THE INVENTION

1. Field of the Invention

The present subject matter relates to a financial product such as a foreclosure insurance policy, and a method and means for producing such a product, including producing a value on which policy premiums are based.

2. Related Art

Currently, the only form of commonly utilized mortgage insurance that exists with respect to home mortgage payments is Private Mortgage Insurance (PMI). PMI is designed to protect the lender in case of a mortgage default. PMI is typically required by a lender for those individuals who qualify for a home loan, but are unable to provide a down payment of 20% or more towards the amount of the home's purchase price. The lender will either require the homeowner to purchase PMI directly from a PMI insurer, or it will charge a higher interest rate on the loan and purchase a PMI product against the loan to hedge and protect itself Either way, if the prospective homeowner is not able to produce a down payment of 20% or more, they will bear the financial burden in one form or another to protect the lender.

Moreover, if the homeowner lives in a state that allows the lender to seek financial recourse against the borrower for losses and costs associated with the foreclosure and subsequent resale of their home (potentially at a price lower than their existing loan balance), they become faced with an even greater financial burden, the likes of which they most likely would not be able to endure. Furthermore, when a homeowner refinances their mortgage loan, the new loan is automatically deemed to have recourse no matter what state they reside in. This allows lenders to sue the homeowner for a variety of losses. Unfortunately, most homeowners are unaware of the consequences they face should they fall into foreclosure.

A problem for homeowners is that PMI protects only the lender. United States Patent Application Publication No. 20050108064 provides for a financial arrangement in which a homeowner's down payment is structured in a manner to avoid the requirement for PMI. The specification points out that consumers do not attach a high value to Private Mortgage Insurance. Private Mortgage Insurance protects the mortgage holder. Consumers do not see how they benefit by paying for insurance to protect another party. While this publication discloses an arrangement to avoid the need for PMI, a vehicle for protection of the homeowner is not provided.

PMI insurance companies use a revenue model in which their income or loss is based on a method that is often analogized to casino gaming. Insurance companies use actuarial data to calculate the likelihood of the occurrence of losses against which they are ensuring. With regard to PMI, statistical data used by actuaries may include likelihood of occurrences such as unemployment of a mortgagor, and drop in home values due to any number of factors. The premium charged will yield a predicted profit to the insurance company if a predicted level of loss in incurred. The insurance company is betting that its prediction is correct.

The prior art has also sought to add functionality to insurance beyond that of ensuring for a specific risk. A conventional policy may be modified to provide an acceptable economic outcome in the event of old currents of a predetermined set of circumstances. For example, U.S. Pat. No. 7,392,202 discloses methods and systems for providing an insurance policy with an inflation protection option. The disclosed method requires tracking economic circumstances and making additional purchases to correct for selected economic circumstances. The additional functionality requires the use of transactions initiated at a later time, and is not built into the initial structure of a product.

### SUMMARY

The present subject matter is directed to an insurance policy and insurance method to protect homeowners from foreclosure and to the production of such a policy. A financial insurance product and a method, means, and a computer program are provided. The policy will financially assure a homeowner for a specified period of time to prevent the foreclosure of the policy holder's home. An insurance company or financial institution agrees to pay on behalf of an insured, the fixed monthly mortgage of the policy holder for a determined period of time based upon occurrence of a triggering event. Examples of a triggering event include a home loan being placed into default and/or being categorized in foreclosure. The subject matter also includes methods of calculating premiums for said policy as well as methods to mitigate risk associated with writing the policy via financial instruments that will effectively hedge its risk.

Briefly stated, in accordance with the present subject matter, a method and means to produce a value of a premium for a financial product, which method may incorporate a method to hedge that product's risk, are provided. In one form, a computer program is provided which uses financial data that has been entered into an insurer's database to produce the value for the premium of an insurance product. The insurance product will pay the monthly mortgage of the homeowner in the event of default on the homeowner's mortgage loan or if the underlying mortgaged property is at risk of being categorized in foreclosure. The value of the policy premium is based on a predetermined set of parameters. Parameters may include the homeowner's monthly mortgage payment, asset valuation, the terms and conditions of the associated mortgage loan, e.g. whether the loan is a first mortgage, and borrower creditworthiness. The foreclosure insurance policy is packaged to allow for the sale, hedging, or reinsurance by the insuring entity. In the preferred form, the hedging vehicle performs in response to the market including the mortgaged property.

### BRIEF DESCRIPTION OF THE DRAWINGS

The accompanying drawings illustrate the various features and aspects of the invention and together with the description, explain the advantages and principles of the invention.

FIG. 1 is a flowchart illustrating the steps performed in order to create an insurance policy;

FIG. 2 is a block diagram of a data processing system suitable for use with the present subject matter;

FIG. 3 is a chart of database fields and input information used within the insurance premium calculation and policy creation;

FIG. 4 consists of FIGS. 4A and 4B, which illustrate the input parameters and calculation of insurance premium and its profitability metrics for insurance policies covering mortgage payments in a first and in a second price range respectively;

FIG. 5 consists of FIGS. 5A, 5B, 5C, and 5D, which illustrate the input parameters and calculations in a hedging process by which an insurer reduces risk through the use of first and second hedging vehicles respectively;

FIG. 6 is a flowchart describing the process that transpires after a Mortgage Foreclosure Insurance policy has been executed between the parties; and

FIG. 7 consists of FIGS. 7A and 7B, which respectively illustrate hedging through the use of a derivative and through the use of a derivative of a derivative.

### DETAILED DESCRIPTION

In accordance with the present subject matter, a financial insurance product and method and means for producing and hedging a product are provided. The financial insurance product affords financial assurance to a homeowner for a specified period of time to forestall the foreclosure of his or her home. The present subject matter enables production of a value for an insurance premium. This value is related to the hazard being insured. The generation of the value employs risk mitigation through the use of a hedging vehicle. A hedge may comprise futures, options, or other instruments, e.g., housing futures for a given geographical area traded on the Chicago Mercantile Exchange.

The present subject matter comprises a form of individual policy having premiums that can either be set at a fixed price, or calculated by multiplying the homeowner's monthly mortgage payment by a percentage rate to be determined by the insurer. The percentage rate could be based upon any individual or combination of factors, which may include conventional parameters in addition to the risk mitigation parameters. These parameters may include marketability in the opinion of the insurer, risk/reward tolerance, projected default ratios (percentage of policies that will have claims made against them), required reserve ratios (the amount of reserve capital to be held at all times as a percentage of total liabilities), the borrower's FICO® score or other form of credit scoring technique, the underlying or existing mortgage loan terms and structure, the respective Loan To Value (LTV) ratio (the amount the loan represents as a percentage of the total value of the home), the geographic projection of a housing market's affordability ratios and/or its respective net present value and future value. The insurance company is not required to rely solely on “playing probabilities” as to the number of losses to be incurred and the cost of the losses.

Since the insurer can mitigate risk, insurance becomes more accessible to homeowners. Said another way, a single policy or a group of policies will contain the ability to be hedged. By combining an insurance policy or group of policies with a hedging vehicle, e.g., a derivative product whose price fluctuates based upon an underlying index, market data or an observable input from which the derivative's value is determined, the insurer can mitigate financial exposure by associating an expected number of claims and their dollar equivalent with the appreciating or depreciating valuation of housing within any given geographic region.

Examples of such derivatives are futures contracts that trade on the Chicago Mercantile Exchange based upon the value of the S&P Case-Schiller Home Price Indices®. Additional examples of indices, market data, and observable inputs that currently have derivative contracts associated with their value and can be used to mitigate the inherent risk of the foreclosure insurance policy are The Markit Group's ABX Indices, The Radar Logic Residential Property Index™ and OFHEO's HPI (Office of Federal Housing Enterprise Oversight's Housing Price Index). The index utilized may be an index for a geographical area in which the insured property is located.

The insurer can enter into contracts for exchange-traded or private over-the-counter futures. Alternatively, the insurer can enter into option contracts with institutions that have created or trade derivative products. Typically the respective derivative's valuation and prices are derived from economic statistics issued by United States Government agencies or by private entities that create and maintain statistics for use in the computing of economic activity. The insurer can use, for example, futures contracts, or derivative option contracts whose valuation is derived based upon the underlying futures or derivative's contract price. The option contracts can be in the form of puts, calls, or any strategy that employs a combination of the two either individually or combined.

The insurer can also enter into forward conversion contracts with any institution for the previously stated risk mitigation objectives either by encompassing the aforementioned techniques and strategies within a forward conversion contract, or by entering into a custom and proprietarily developed forward conversion contract or swap contract.

These techniques and strategies can be implemented for a single policy or implemented by combining numerous individual policies to form a group of policies and or entered into as separate tranche transactions with the purpose of mitigating losses associated with any potential policy claims from policies that are comprised of similar amounts of financial risk and or structure of risk tolerance. Similar to futures and futures options contract strategies, risk can also be mitigated by purchasing re-insurance on an individual mortgage foreclosure insurance policy, a pool of mortgage foreclosure insurance policies, or a tranche of mortgage foreclosure insurance policies. Reinsurance transactions for an individual policy, a group of policies, or a tranche of policies can be entered into as separate transactions notwithstanding any additional hedging techniques or strategies that are employed with the purpose of mitigating losses associated with any potential policy claim or claims.

If a triggering event occurs, the policy holder will file a claim on the policy. Examples of triggering events include the mortgage loan being placed into default or being categorized as being delinquent or in foreclosure The definition of a triggering event could also be written to include a status where events leading up to the foreclosure process have occurred. Following the claim notification, the insurer will contact the lender and or loan servicer and verify the validity of the claim either via written, verbal, or electronic correspondence. Once the claim has been deemed valid, the insurer will begin payment to the lender or servicer under the terms and conditions of the respective policy.

In the instance that no triggering event occurs, the policy will renew with all terms and conditions contained within the previous policy unless terminated by either the insurer or the insured.

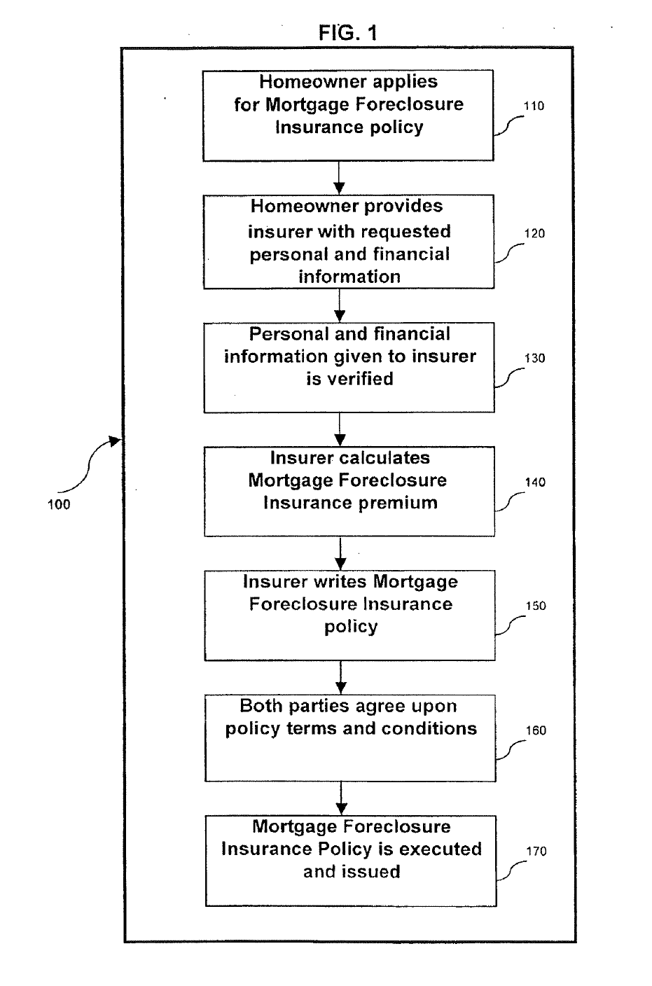

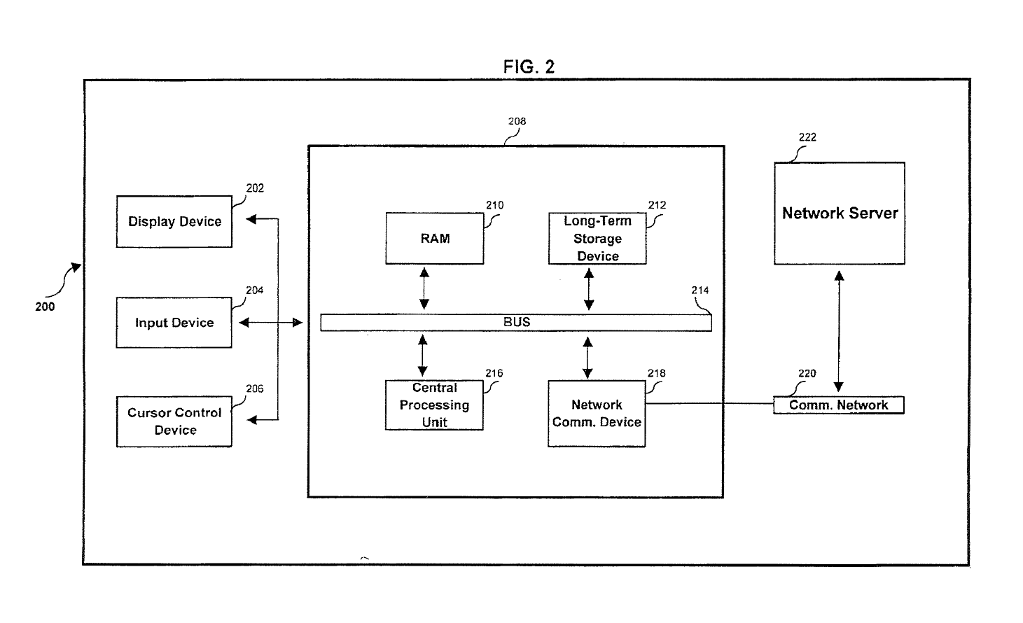

FIG. 1 is a flowchart illustrating a context for the present subject matter. In a process 100 to initiate coverage, a homeowner applies for insurance at block 110. At block 120, the homeowner provides information to the insurer regarding selected parameters, which are discussed further with respect to FIG. 2. At block 130, the insurer verifies all personal and financial information provided by the homeowner.

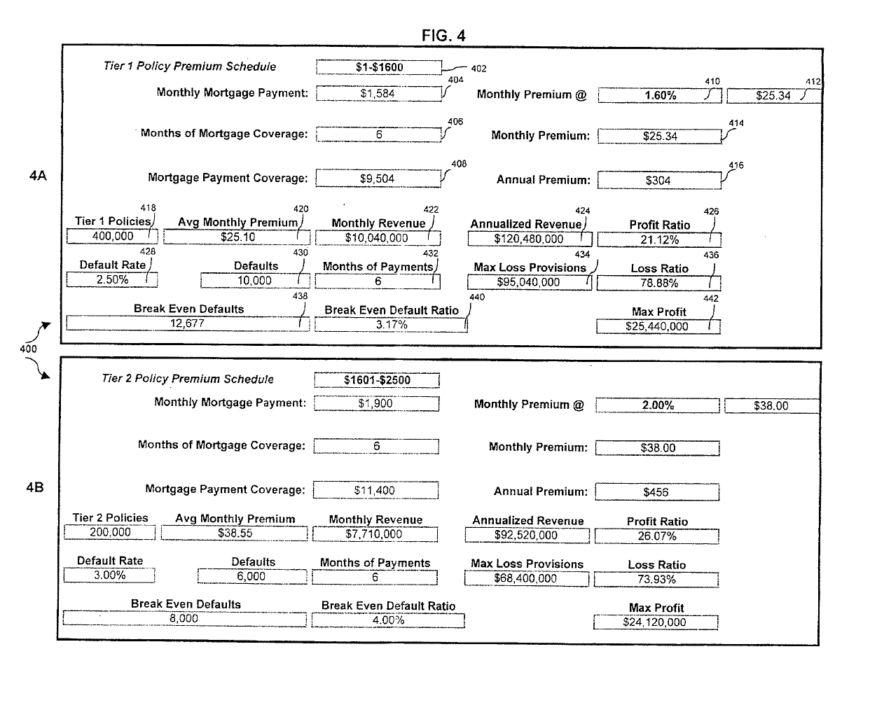

At block 140, the insurer determines annual and/or monthly premiums. The premium has a structure comprising a first component related to a rate category and a second component based on a hedge selected for it mitigating risk of loss with respect to the insured interest premium is based on a number of components. A first component may be based on commonly used standard actuarial formulas as well as any subjective or other criteria that are included in the insurer's business model. Conventional parameters include credit worthiness of the borrower, percentage of loan to equity in the subject house, and a number of other factors. The rate is also a function of factors calculated in accordance with the present subject matter (further discussed with respect to FIG. 4). For purposes of the present description, selecting a combination of conventional parameters on which the premium will be based is referred to as determining a rate category. Assigning a value on which the component of premium due to this first factor is referred to for purposes of the present description as determining a premium component for the rate category.

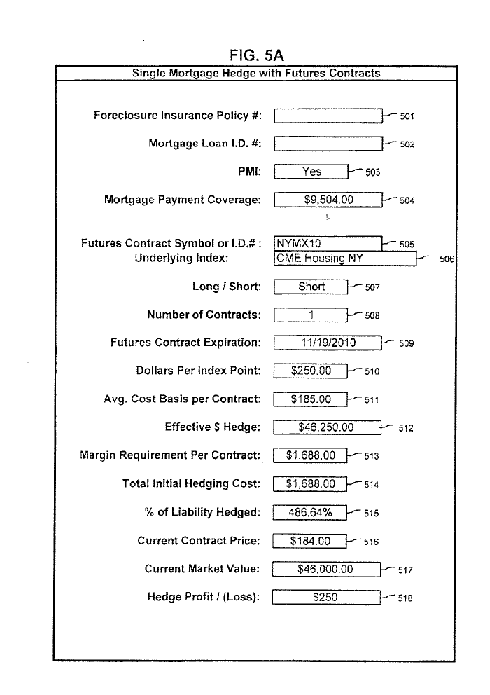

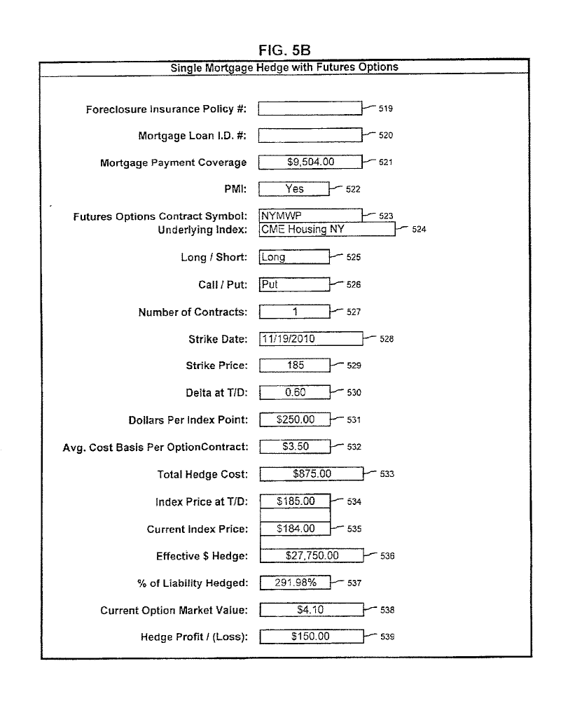

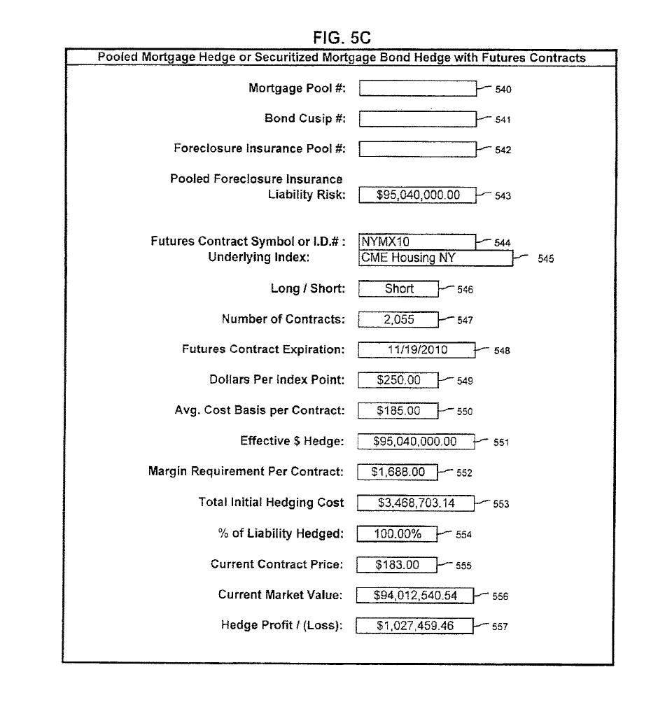

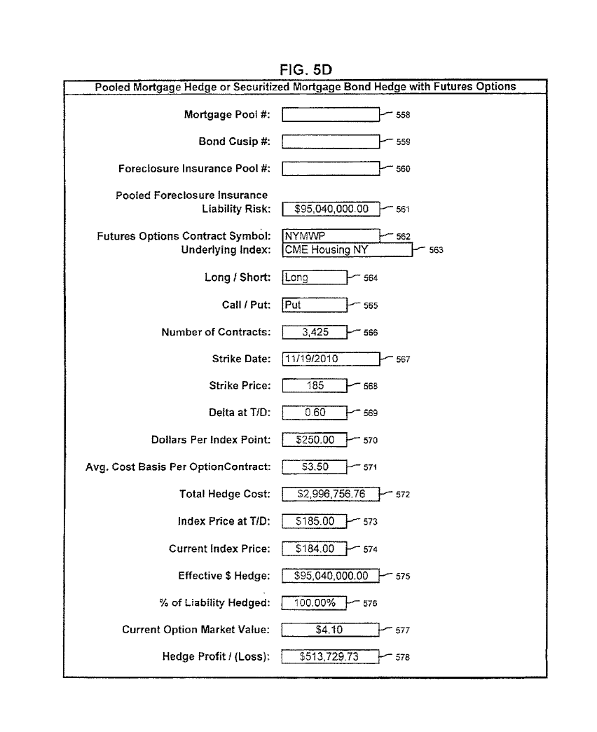

A second component of the rate is based on risk mitigation achieved through hedging the insured interest. The hedging process is described in detail below. For purposes of the present description, selecting a hedging procedure, i.e., selecting the various parameters discussed with respect to FIGS. 4 and 5, and determining costs in connection therewith is referred to as determining a hedging cost. Assigning a value on which the component of premium due to this second factor is referred to for purposes of the present description as determining a hedging premium component. The insurer will determines the premium by combining the cost components due to risk along with other price components, e.g., profit and overhead. This determination of the premium is referred to as establishing an insurance premium based upon a predetermined relationship between the cost level and the premium. The relationships are embodied in rules, as further described below.

At block 150, the insurer writes the foreclosure insurance policy. At block 160, both parties agree to the terms and conditions set forth within the policy. Once the parties agree on the terms, the foreclosure insurance policy is executed and issued at block 170.

FIG. 2 illustrates a block diagram of data processing system 200 in which methods and systems consistent with the present invention may be implemented. The data processing system 200 includes a display device 202, an input device 204, and a cursor control device 206 which each interact with a computer 208. The data processing system 200 further comprises a communications network 220 and a network server 222.

The computer 208 also comprises a bus 214 or other electronic communication mechanism used for transmitting data within and between computer systems and peripherals, a central processing unit 216, a random access memory 210, long-term storage devices 212, and a network communication device 218. The computer 208 in the present illustration communicates within and between device display 202, input device 204, and cursor control device 206 takes place via the bus 214. Within the computer 208, bus 214 acts as the electronic communication mechanism that allows simultaneous communication between random access memory 210, long-term storage device 212, and central processing unit 216. Communication between the computer 208 and network server 220 takes place via network communication device 218, which uses a communication network 222. Communication network 222 can be in the form of any current or future networking systems such as a local area network, a wide area network, a virtual private network, or a direct closed network.

The computer 208 and apparatus interacting therewith can respond to commands of a machine-readable medium. A machine-readable medium includes any mechanism that provides (i.e., stores and/or transmits) information in a form readable by a machine (e.g., a computer). For example, a machine-readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.) etc. The particular architecture illustrated of the data processing system 200 is illustrative of the functions performed, and many alternatives may be provided.

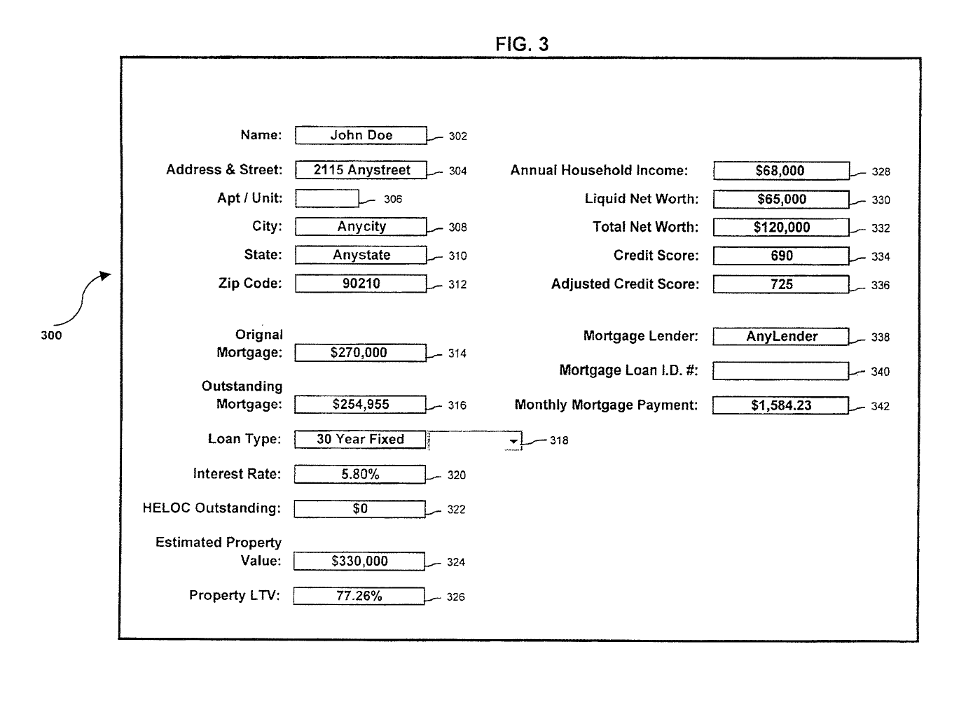

FIG. 3 is a chart 300 comprising database fields. The database fields comprise the information used to produce a value on which an insurance premium is based and information utilized for administration of policies. The set of parameters used in FIG. 3 is illustrative. Fewer or additional parameters could be utilized.

FIG. 3 may be viewed in a number of ways. FIG. 3 is illustrative of one form of data structure for the long-term storage device 212 (FIG. 2). FIG. 3 also represents a graphical user interface provided on the display device 202. Additionally, FIG. 3 represents a portion of the software architecture for operating a system in accordance with the present subject matter.

Chart 300 includes input fields for information such as mortgagor name, property address, and select mortgage loan information. In the present illustration, fields 302-312 contain information identifying the homeowner and the home. Field 302 includes the name of the homeowner. Fields 304 and 306 are used for first and second address lines. The name fields 308, 310 and 312 respectively record city, state, and zip code. If desired, a legal description of the property as recorded in County Clerk title records could also be included.

Fields 314-316 contain information relating to current financial information regarding the home. Fields 314 and 316 illustrate an original mortgage amount and a current value of remaining balance respectively. Fields 318 and 320 respectively contain information on the type of loan, e.g., fixed or adjustable, and interest-rate respectively. Field 322 is used to indicate whether there is an outstanding value. In field 324, an estimated property value is illustrated, while field 326 illustrates the ratio of the loan balance to the property value, i.e., the mortgage amount plus the amount secured by a property interest in the house, expressed as a percentage.

Fields 328-336 contain information about the homeowner. Fields 328, 330, and 332 respectively represent annual household income, liquid net worth, and total net worth. Fields 334 and 336 respectively represent credit score and adjusted credit score. The most common credit score used is a proprietary computational score generated by this Fair Isaac Corporation known as FICO®. The adjusted credit score is a score that the homeowner would have but for the factor which is excluded from the calculation for purposes of the adjustment. For example, in a market with a historically high level of foreclosures, the inventors herein contemplate that credit score and rating agencies will create an additional credit score that reflects the credit worthiness of a borrower if he or she had not gone into foreclosure.

Fields 338-342 contain information about the current mortgage. Fields 338, 340, and 342 respectively represent the name of the lender, identification of the mortgage loan, and the monthly mortgage payment. Field 340 represents the loan identification number that is assigned to all mortgage loans outstanding for purposes of organization, tracking, payment association, deed ownership, and reconciliation. Field 342 represents the data base field containing the mortgagor's monthly mortgage payment.

FIG. 4, consisting of FIGS. 4A and 4B, illustrates one exemplary method 400 of producing a value for the monthly premium of a Mortgage Foreclosure Insurance product. Additionally, profitability metrics may be generated. It is common practice for an insurance company to establish different tiers of rates for different ranges of pay-off benefits. FIG. 4A corresponds to a first tier premium level for a policy providing payment coverage of $1-$1600. FIG. 4B corresponds to a first tier premium level for a policy providing payment coverage of $1601-$2500. Additional or alternative ranges may be established.

In FIG. 4A, field 402 specifies a range for a tier. Fields 404 and 406 will identify the benefits under the insurance policy, namely the monthly mortgage payment which is insured and the number of months of payments that can be made under the policy respectively. Field 408 identifies the total liability of mortgage payments insured by the insurer. Premium information is specified in the fields 410-416. Fields 410 and 412 represent the price for coverage as a percent of monthly mortgage payment and as a dollar value respectively. Fields 414 and 416 respectively illustrate monthly and annual premiums.

Fields 418 through 442 provide information to the insurance company indicative of profitability metric for one illustrative scenario. Fields 418, 420, and 422 respectively represent a particular number of policies that are in effect in one tier, the average monthly premium per policy and the total monthly revenue for that tier of policies. Fields 424 and 426 respectively represent annualized revenue in that tier and profit ratio. Fields 428, 430 and 432 respectively represent a projected default rate, the numerical value of that percentage based on the information in field 418, and the number of payments for which the insurer will be liable. This data allows the insurer to analyze the-magnitude of risks.

FIG. 5 is a chart illustrating parameters utilized in creating a foreclosure insurance policy in accordance with the present subject matter. The policy embodies a hedging process by which an insurer reduces risk and in which the insurer may relate the premium to market values having an association with the value of the mortgaged property. FIG. 5 consists of FIGS. 5A, 5B, 5C, and 5D which illustrate the input parameters and calculations in a hedging process by which an insurer reduces risk through the use of first and second hedging vehicles respectively. FIG. 5 is illustrative of a graphical user interface on the display device 202 (FIG. 2), data structure within the long-term storage device 212, and a program for execution on a processor.

The operations described below may be performed on the computer 208 (FIG. 2) in response to a machine-readable medium provided in accordance with the present subject matter. The factors and terms utilized in the calculations below may be accessed from their respective locations in the long-term storage device 212. These calculations may be performed in the central processing unit 216.

In the present illustration, a single policy or group of policies as illustrated in FIGS. 4A and 4B are being hedged. FIG. 5A illustrates the use of a derivative, for example a futures contract as a hedging vehicle for an individual mortgage policy. Identification information is provided in Fields 501, 502, and 503, which respectively indicate an insurance policy number, identity of the mortgage loan to which the insurance applies, and whether the homeowner is carrying PMI for benefit of the lender. Field 504 represents the amount needed to be hedge by the insurer. This value is obtained from field 408 in FIG. 4A or 4B respectively.

Fields 505 through 518 relate to the hedging vehicle used in conjunction with the foreclosure insurance policy. Fields 505 and 506 respectively identify a futures contract symbol and the name of the index corresponding to that symbol. A number of hedging vehicles are available. In the present illustration, the symbol of the particular futures contract utilized is NYMX10. This illustrated symbol is the identifier of the S&P Case Schiller Housing Index futures contract for the New York City metropolitan area. This illustrated index future contract is traded on the Chicago Mercantile Exchange. This is a vehicle best suited for hedging a policy on a house in the New York City metropolitan area. The Chicago Mercantile Exchange maintains futures contracts for many metropolitan areas in the United States. However, it is not necessary that the hedging vehicle be a futures contract. Broker-dealers may create their own derivative contracts or forward conversion contracts that may be utilized for identical purposes.

Field 507 indicates whether the position taken is long or short. In the present illustration, a short position is taken. A short position is best explained as the sale of a “borrowed” security, commodity, currency, or derivative with the expectation that the asset that was sold short will fall in value. The asset must eventually be returned to whom it was “borrowed” from by buying it back on the open market. If the asset is purchased on the open market at a price that is lower than the price it was sold short at, a profit is made. Fields 508 and 509 indicate the number of contracts which have been bought or sold short and their expiration date respectively. The futures contracts on the Chicago Mercantile Exchange always expire on the third Friday of their designated expiration month. Fields 510 and 511 respectively indicate dollar per index point and the average cost basis per contract. Multiplying the value is in fields 508, 510 and 511 yields a total value of the effective dollar hedge, noted in field 512. Field 513 represents the margin requirement per futures contract as dictated by the Chicago Mercantile Exchange. Field 514 represents the total initial cost of entering into the hedging position and is calculated by multiplying field 513 by field 508. Field 515 is used to indicate the percentage of the risk which has been hedged. This percentage is determined by dividing the value in field 512 by the value in field 504. The current value of the respective underlying index is shown in field 516.

The current financial position for this hedge may be found by determining a current market value, as by viewing a “ticker” or “symbol” listing price of the current market or marketable price of the illustrated futures contract utilized, to be shown in field 516, and comparing the current market value to the cost basis. The cost basis may be seen in field 514. The cost basis is usually the purchase price paid by the insurer or a value arrived at through standard accounting procedures for property acquired other than by a cash purchase. Hedge profit or loss is entered in field 539. The current market value of the position to be listed in field 517 is determined by multiplying the values in fields 508, 510 and 516. The value in field 518 represents the total profit or loss value for the hedge and is determined by subtracting field 517 from field 512.

FIG. 5B illustrates the use of a derivative of a derivative, for example a futures options contract, as a hedging vehicle for a single mortgage policy. Fields 519 and 520 respectively identify serial numbers of a foreclosure insurance policy and corresponding mortgage loan. These identification numbers could be used in addition to or in the alternative to names. For administrative purposes, Fields 521 and 522 may be provided respectively indicating the monthly mortgage payment coverage and whether the mortgage has PMI coverage.

Fields 523 and 524 contain the symbol and name of a futures option contract respectively. Fields 525, 526, 527, and 528 respectively represent the position taken, i.e., long or short, the nature of the option, i.e., put or call, the number of contracts, and the strike date. The strike price is listed in field 529, and the delta of the option is listed in field 530. The delta of an option is defined as the rate of change of the option price with respect to the change in price of the underlying asset from which its value is determined. For example, an option with a 0.65 delta will increase or decrease in value by 65% of the change in value of the underlying index. Therefore every $1 change in value of the underlying index equates to the option increasing or decreasing in value by 0.65 cents. Dollars per index point are listed in field 531, while cost basis per option contract is contained in field 532. Fields 534 and 535 respectively represent an index price at the original transaction date and a current index price.

The total cost of the hedge is shown in field 533. In field 536, the total dollar value that has been hedged as a result of the purchase of the contracts at their calculated delta is listed. This effective hedge is compared to the value in field 521 and is expressed as a percentage seen in field 537. Current financial position for this hedge may be found by first determining a current market value, as by viewing a “ticker” or “symbol” listing of the current market or marketable price of the illustrated futures option contract utilized, to be listed in field 538. The current value is then compared to the basis, i.e., the purchase price paid by the insurer or a value arrived at through standard accounting procedures for property acquired other than by a cash purchase. Hedge profit or loss is entered in field 539. The options have not been exercised at this point, and the value in field 539 may be referred to as “paper profit” or “paper loss.” In order to determine a current profit or loss value, the value in field 532 is subtracted from the value in field 538. The resulting difference is then multiplied by the product obtained by multiplying the values in fields 527 and 531.

FIG. 5C illustrates the use of a pooled mortgage hedge or a securitized mortgage bond hedge with futures contracts as a hedging vehicle. Fields 540, 541 and 542 respectively refer to identification numbers of a mortgage pool, a bond CUSIP (a unique identifier assigned to a bond at the time it is issued) and a foreclosure insurance pool. These identification numbers could be used in addition to or in the alternative to names. Field 543 lists the pooled foreclosure insurance liability risk.

Fields 544 and 545 contain the symbol and name of a futures contract respectively. Fields 546, 547, 548 respectively represent the position taken, i.e., long or short, the number of contracts utilized for the hedge, and the futures contract expiration date. Dollars per index point are listed in field 549, while the average cost basis per futures contract is contained in field 550. Field 551 represents the effective dollar amount of the hedge. The value in field 551 is obtained by multiplying the values in the fields 547, 549, and 550.

Margin requirements per contract and total initial hedging costs are seen in fields 552 and 553. The percent of liability the hedge is represented in field 554. This value is obtained by dividing the value in field 551 by the value and field 543. Current financial position for this hedge may be found by first determining a current index price, as by viewing a “ticker” or “symbol” listing price of a current-market or marketable price of the illustrated futures contract utilized, to be shown in the field 555 and comparing the current market value to the initial hedging cost shown in field 553. The current market value of the position shown in field 556 is determined by multiplying the values in fields 547, 555 and 549. In order to determine a current profit or loss value for the hedge, the value in field 556 is subtracted from the value in field 551. Hedge profit (a positive result) or loss (a negative result) is entered in field 557.

FIG. 5D illustrates the use of a pooled mortgage hedge or a securitized mortgage bond hedge with futures options as a hedging vehicle. Fields 558, 559, and 560 respectively refer to identification numbers of a mortgage pool, bond CUSIP (a unique identifier assigned to a bond at the time it is issued) and a foreclosure insurance pool. These identification numbers could be used in addition to or in the alternative to names. Field 561 lists the pooled foreclosure insurance liability risk.

Fields 562 and 563 contain the symbol and name of a future options contract respectively. Fields 564, 565, 566, and 567 respectively represent the position taken, i.e., long or short, the type of option, i.e., a put or call, the number of contracts utilized for the hedge, and the futures contract expiration date. The option contract's strike price is listed in field 568, and the delta at the initial transaction date is listed in field 569. Dollars per index point are listed in field 570, while average cost basis per option contract is contained in field 571. The total cost of the hedge is shown in field 572.

The index price at the initial transaction date and a current index price are listed in fields 573 and 574 respectively. In field 575, the effective dollar amount of the hedge is presented. The percent of liability hedged is represented in field 576. This value is obtained by dividing the value in field 575 by the value and field 561. Current financial position may be found by first determining the current market value or marketable price of the illustrated futures option contract utilized, as by viewing a “ticker” or “symbol” listing price to be shown in the field 577, and comparing the current market value to the average cost basis. In order to determine a current profit or loss value, the value in field 577 is subtracted from the value in field 571. The resulting difference is then multiplied by the product obtained by multiplying the values in fields-566 and 570. Hedge profit (a positive result) or loss (a negative result) is entered in field 578.

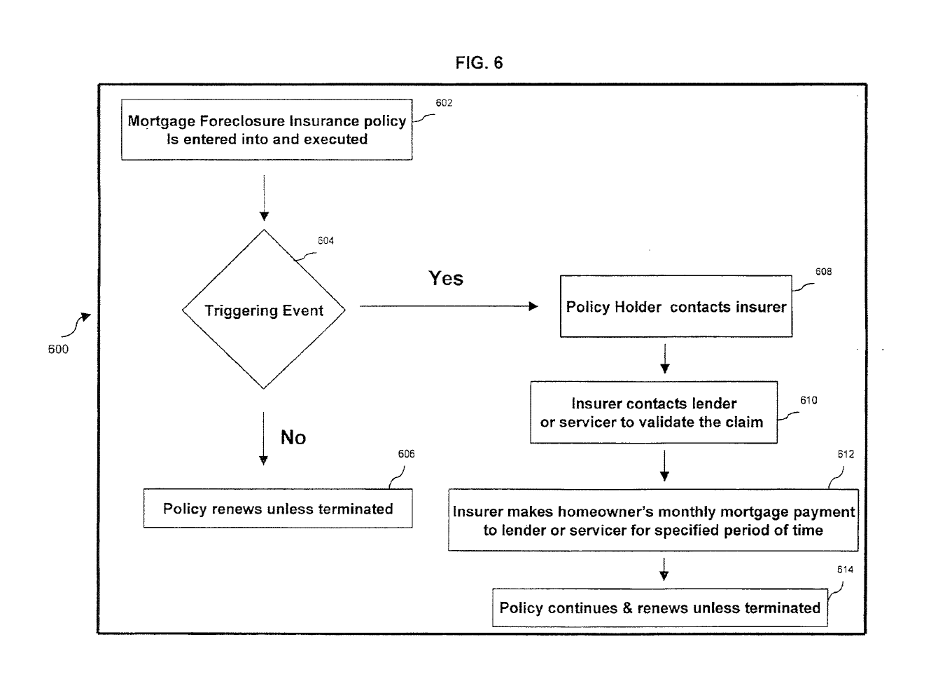

FIG. 6 is a flowchart describing a process 600 that transpires after a Mortgage Foreclosure Insurance policy has been executed between the parties at block 602. The insurance coverage, once in effect, will cover the homeowner should a triggering event occur. A triggering event is defined in the policy. In one illustrative scenario, a triggering event is a homeowner's going into default according to the terms of their mortgage.

The occurrence of a triggering event is detected at block 604. Should no triggering event occur, the process proceeds to block 606 at which the policy would renew unless terminated by the mortgagor or the insurer. Should a triggering event occur, the process proceeds to block 608, at which a policyholder contacts the insurer. At block 610, the insurer performs its procedure to validate the claim. Once the claim is validated, the insurer executes the agreed-upon performance at block 612. The agreed-upon performance may, for example, comprise the insurer's paying the homeowner's monthly mortgage for a specified period of time.

At block 614, it is determined whether the benefits payable under the policy have been exhausted. If so, coverage ends at block 614. If the policy has remaining benefits, monitoring continues at block 604. Another triggering event would be sensed at block 604 to start the process once again.

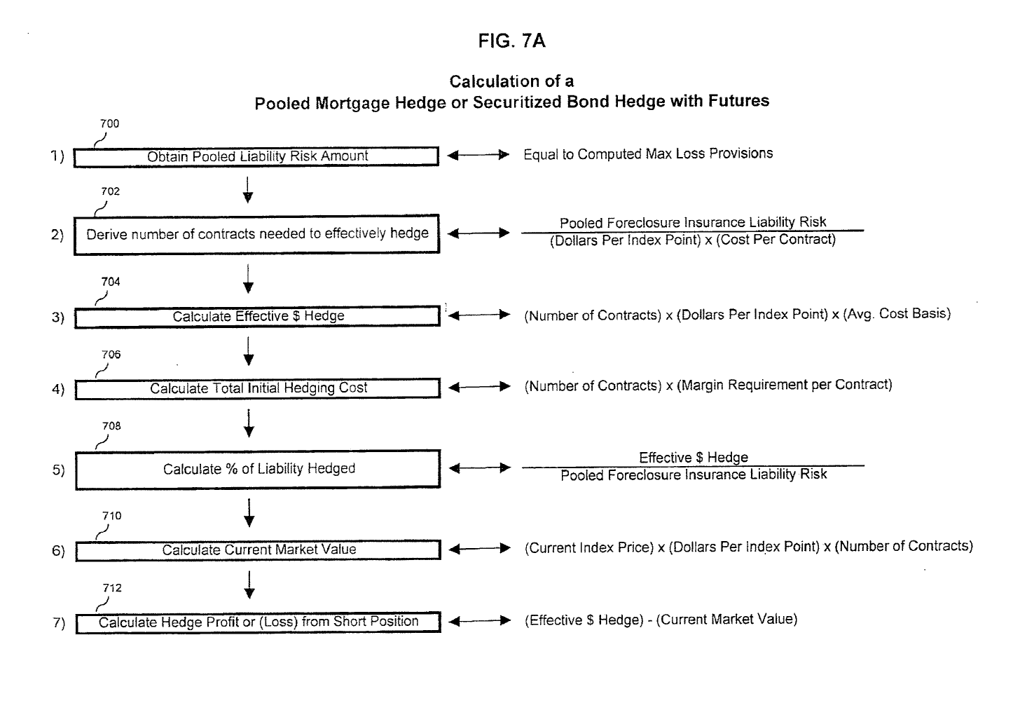

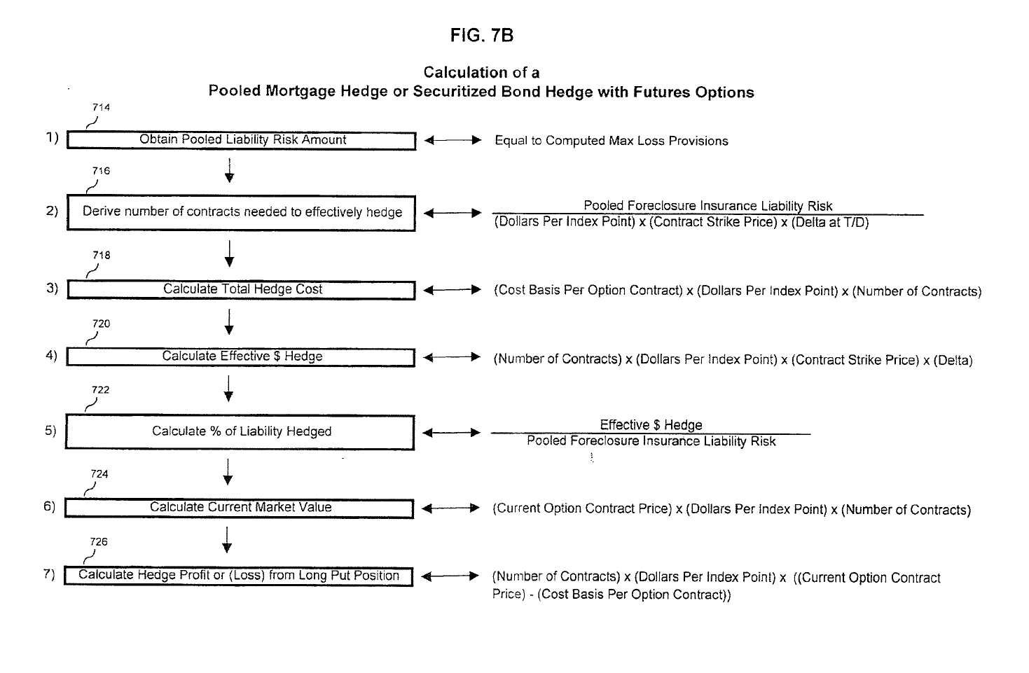

FIG. 7A is a flowchart illustrating the use of futures to hedge against the losses in the interest insured by the insurance company. This interest may be embodied in a pooled mortgage or securitized bond. FIG. 7B is a flowchart illustrating the use of a futures derivative to hedge against losses in short interest. In the illustration in FIG. 7B, the further derivative comprises a futures option. Other derivatives could be utilized. It is preferred that the derivative be related to the value of the housing market including the insured property. Where a subsequent calculation is not dependent on a previous calculation, the order of steps in FIGS. 7A and 7B may be altered.

The operations described below may be performed on the computer 208 (FIG. 2) in response to a machine-readable medium provided in accordance with the present subject matter. The Factors and terms utilized in the calculations below may be accessed from their respective locations in the long-term storage device 212. These calculations may be performed in the central processing unit 216.

The calculation of the values associated with hedging the insured interest with futures contracts is illustrated in FIG. 7A. At block 700, the pooled liability risk amount is accessed. In one embodiment, the value is accessed from the memory location represented by field 434 in FIG. 4A. Next, at block 702, the number of futures contracts needed to hedge effectively is derived. This is derived by dividing the value at block 700 by dollars per index point times the cost per contract. At block 704 the number of contracts times the dollars per index point times the average cost basis per contract are multiplied together to produce a value of the effective monetary hedge. The total initial hedging cost is calculated at block 706 by multiplying the number of futures contracts by the margin requirement per contract. At block 708, the percent of liability hedged is calculated. This is done by accessing the memory location represented by block 704 and dividing it by the pooled foreclosure insurance liability risk used in the calculation at block 700. At block 710, the current market value of the hedge is calculated. This is equal to the current contract price times the dollars per index point times the number of contracts. At block 712, the hedge profit or loss from a short position is determined by subtracting the current market value calculated at block 710 from the effective dollar hedge calculated at block 704.

The calculation of the values associated with hedging the insured interest with futures options is illustrated in FIG. 7B. At block 714, the pooled liability risk amount is accessed. In one embodiment, the value is accessed from the memory location represented by field 434 in FIG. 4A. Next, at block 716, the number of option contracts needed to effectively hedge is derived. This quotient is derived by dividing the value at block 714 by the product obtained by multiplying the dollars per index point times the option contract strike price times the Delta at the initial transaction date. The total initial hedging cost is calculated at block 718 by multiplying the cost basis per option contract times the dollars per index point times the total number of option contracts. At block 720, in order to calculate the effective and monetary hedge value, the number of option contracts times the dollars per index point times the option contract strike price times the Delta is calculated. At block 722, the percent of liability hedged is calculated. This is done by accessing the memory location represented by block 720 and dividing it by the pooled liability risk located in block 714. At block 724, the current market value of the hedge is calculated. This equals the current option contract price times the dollars per index point times the number of option contracts. At block 726, the hedge profit or loss resulting from a short position is determined by subtracting block 724 from block 718.

The financial product provided is a unit of coverage which the insurer may hedge in a dynamic matter. The hedging vehicle may be modified either occasionally or frequently for optimization of risk mitigation. The product is dynamically adjusted in relation to current real estate values. The financial product according to the present subject matter is not related solely to periodically updated actuarial factors. Rather it is current and dynamic.

This subject matter will serve a critical role in allowing individual homeowners to protect themselves against any unforeseen economic and financial hardship they may encounter while owning a home. This product is designed to provide peace of mind during financial distress and transition by allowing the homeowner to obtain other means in order to satisfy their financial obligation to their mortgage lender. Homeowners can avoid home foreclosures and the resulting adverse financial consequences. A homeowner can use the precious time allotted to them by their policy to renegotiate a new loan with their lender, sell their home, or obtain other financial arrangements.

While the foregoing written description of the subject matter enables one of ordinary skill to make and use what is considered presently to be the best mode thereof, those of ordinary skill will understand and appreciate the existence of variations, combinations, and equivalents of the specific embodiment, method, and examples herein. The subject matter should therefore not be limited by the above described embodiment, method, and examples, but by all embodiments and methods within the scope and spirit of the subject matter as claimed.

1. A method for providing borrower foreclosure insurance for insured interests in real property, each classified in a rate category, comprising:
a. receiving data at a processor of a computer, the data being indicative of a rate category respectively associated with each real property interest;
b. controlling the processor to calculate a premium for at least some of the real property interests with a rule utilizing the data indicative of the rate category and storing the calculation;
c. receiving data at a processor, the data being indicative of a cost of a hedge vehicle respectively associated with each real property interest;
d. selecting each hedge vehicle based on an index for real property in a preselected geographical area;
e. selecting a monetary level to hedge;
f. selecting at least one type of hedge vehicle and storing a value associated with each type of hedge vehicle; and
g. calculating on the processor a number of hedge contracts of at least one type to achieve hedging of the monetary level.

2. A method according to claim 1 wherein the step of controlling the processor to calculate a premium further comprises interests with a rule further utilizing the data indicative of mortgage payments and a mortgage balance for a respective real property interest.

3. A method according to claim 1 wherein the hedge vehicle comprises a pooled mortgage hedge.

4. A method according to claim 3 wherein the hedge vehicle further comprises futures contracts.

5. A method according to claim 3 wherein the hedge vehicle further comprises futures options contracts.

6. A method according to claim 1 wherein the hedge vehicle comprises a securitized bond hedge.

7. A method according to claim 6 wherein the hedge vehicle further comprises futures contracts.

8. A method according to claim 6 wherein the hedge vehicle further comprises futures options contracts.

9. A method according to claim 1 wherein the hedge vehicle comprises a single mortgage hedge.

10. A method according to claim 9 wherein the hedge vehicle further comprises futures contracts.

11. A method according to claim 9 wherein the hedge vehicle further comprises futures options contracts.

12. A method according to claim 1 wherein the hedge vehicle comprises swap contracts, forward conversion contracts, or futures options contracts.

13. A method for providing borrower foreclosure insurance according to claim 1 further comprising the step of calculating a pooled liability risk amount for the insured interests and wherein the step of selecting a monetary level to hedge comprises selecting the monetary level as a function of the pooled liability risk amount.

14. A method for providing borrower foreclosure insurance according to claim 1 wherein selecting the hedge vehicle based on an index for real property in a preselected area comprises selecting an index calculated for the United States.

15. A method for providing borrower foreclosure insurance according to claim 1 wherein selecting the hedge vehicle based on an index for real property in a preselected area comprises selecting an index calculated for a selected metropolitan area.

16. A method for providing borrower foreclosure insurance according to claim 1 wherein selecting the hedge vehicle based on an index for real property in a preselected area comprises selecting an index calculated for a selected metropolitan area including the real property.

17. A non-transitory machine-readable medium that provides instructions, which when executed by a processor, causes said processor to perform operations comprising:
a. receiving data at a processor of a computer, the data being indicative of a rate category respectively associated with each real property interest;
b. controlling the processor to calculate a premium for at least some of the real property interests with a rule utilizing the data indicative of the rate category and storing the calculation;
c. receiving at a processor of a computer data indicative of a cost of a hedge vehicle respectively associated with each real property interest;
d. selecting each hedge vehicle based on an index for real property in a preselected geographical area; and
e. selecting a monetary level to hedge;
f. selecting at least one type of hedge vehicle and storing a value associated with each type of hedge vehicle; and
g. calculating on the processor a number of hedge contracts of at least one type to achieve hedging of the monetary level.

18. A non-transitory machine-readable medium according to claim 17 further providing instructions to: access current hedge values; calculate a current profit or loss position; compare the current position to a preselected threshold; and provide indications of a current profit/loss position.

19. A non-transitory machine-readable medium according to claim 18 further providing instructions to: respond to entries indicative of policy claims; calculating risk level adjustment in accordance with claims; and in response to a preselected threshold exercising the hedging vehicle.

20. A non-transitory machine-readable medium according to claim 17 further providing instructions to cause said processor to perform operations comprising:
a. providing to the processor data indicative of a value based on performance of the hedge vehicle during an initial term;
b. receiving data at a processor, the data being indicative of a cost of a current hedge vehicle respectively associated with each real property interest; and
c. calculating the cost of a hedge vehicle as a function of the cost of the hedge vehicle during the initial term and the cost of the current hedge vehicle.

21. A non-transitory machine-readable medium according to claim 17 wherein controlling the processor to calculate a premium for the property interests with a rule utilizing the data indicative of the rate category comprises using a rule further utilizing data indicative of mortgage payments and a mortgage balance for a respective real property interest.

22. A real property foreclosure insurance financial product for real property in a location, comprising: a unit of coverage available for issue by an issuer; said unit of coverage having a premium based on determination of a rate category; said unit further having a premium dynamically adjusted based on risk mitigation by hedging against values of real property in a statistical area including the location; the insurance policy being renewable and having a renewal premium including a value based on performance of the hedge during an initial term.

23. A non-transitory machine-readable medium according to claim 12, controlling the processor to calculate a premium for the property interests with a rule utilizing the data indicative of the rate category comprises using a rule further utilizing data indicative of mortgage payments and a mortgage balance for a respective real property interest.
